(19) United States
(12) Patent Application Publication
(10) Pub. No.: US 2026/0312457 A1
(43) Pub. Date: Oct. 8, 2026

(54) CONTROL ENCLOSURES INCLUDING INTERNAL GROOVES AND MOTOR ASSEMBLIES INCLUDING SAME

(71) Applicant: Regal Beloit America, Inc., Milwaukee, WI (US)

(72) Inventors: Kevin Gerard Nowobilski, Fort Wayne, IN (US); Jeevan G. Robinson, Fort Wayne, IN (US); Michael Herbert Braun, Fort Wayne, IN (US)

(21) Appl. No.: 19/098,122

(22) Filed: Apr. 2, 2025

(51) Int. Cl. H02K 5/18

(52) U.S. Cl. CPC H02K 5/18

(57) ABSTRACT

Embodiments of the present disclosure are directed to a control enclosure for motor assemblies. The control enclosure includes an end wall including an inner surface and an outer surface opposite the inner surface, and a sidewall extending perpendicularly from the inner surface of the end wall. The sidewall includes an interior surface formed adjacent the inner surface of the end wall. The control enclosure also includes a first plurality of grooves in the inner surface of the end wall, and a second plurality of grooves in the interior surface of the sidewall.

### BACKGROUND

The field of the disclosure relates generally to motor assemblies, and more particularly, control enclosures including internal grooves for improving heat transfer during operation.

In the field of motor assemblies, control enclosures have traditionally been designed to protect the internal components of the motor from environmental factors such as dust, moisture, and mechanical damage. These enclosures form a protective housing for the motor's internal mechanisms. Previous designs have focused on enhancing the structural integrity and durability of the control enclosures, often utilizing materials such as metals or high-strength polymers to withstand external forces and prevent ingress of contaminants.

One common approach in the design of control enclosures has been the incorporation of grooves or channels on the external surfaces of the enclosures. These channels serve various purposes, such as facilitating the dissipation of heat generated by the motor during operation, providing pathways for wiring or other components, and enhancing the overall rigidity of the enclosure. The configuration and placement of these channels have been optimized in some designs to improve the thermal management of the motor assembly.

Additionally, some control enclosures have been designed with a focus on ease of assembly and maintenance. This has led to the development of modular designs where the control enclosure can be easily attached or detached from the motor assembly, allowing for quick access to the internal components for repair or replacement. These designs often include features such as snap-fit mechanisms or threaded connections to secure the control enclosure in place while still permitting easy removal when necessary.

However, with increased power in motor assemblies, as well as additional electronic components included in motor assemblies to improve operation, the amount of heat generated during operation has increased. Therefore, there is a need to create a control enclosure that is capable of transferring and dissipating heat, without increasing size, weight, and cost to motor assemblies.

### BRIEF DESCRIPTION

In one embodiment, a control enclosure for a motor assembly is described. The control enclosure includes an end wall including an inner surface and an outer surface opposite the inner surface, and a sidewall extending perpendicularly from the inner surface of the end wall. The sidewall includes an interior surface formed adjacent the inner surface of the end wall. The control enclosure also includes a first plurality of grooves in the inner surface of the end wall, and a second plurality of grooves in the interior surface of the sidewall.

In an additional embodiment, an assembly for a motor assembly is described. The assembly includes at least one main frame defining an internal main frame cavity; and a control enclosure coupled to an end of the at least one main frame. The control enclosure includes an end wall including an inner surface and an outer surface opposite the inner surface, and a sidewall extending perpendicularly from the inner surface of the end wall. The sidewall includes an interior surface formed adjacent the inner surface of the end wall. The control enclosure also includes a first plurality of grooves in the inner surface of the end wall, and a second plurality of grooves in the interior surface of the sidewall.

In another embodiment, a motor assembly is described. The motor assembly includes an assembly including at least one main frame defining an internal main frame cavity, and a control enclosure coupled to an end of the at least one main frame. The control enclosure includes an end wall including an inner surface and an outer surface opposite the inner surface, and a sidewall extending perpendicularly from the inner surface of the end wall. The sidewall includes an interior surface formed adjacent the inner surface of the end wall. The control enclosure also includes a first plurality of grooves in the inner surface of the end wall, and a second plurality of grooves in the interior surface of the sidewall. The motor assembly also includes a motor disposed within the internal main frame cavity, and the motor includes a shaft.

### BRIEF DESCRIPTION OF THE DRAWINGS

FIG. 1 is a perspective view of an exemplary motor assembly;

FIG. 2 is a partially exploded perspective view of the motor assembly shown in FIG. 1;

FIG. 3 is a top perspective view of a control enclosure included in the motor assembly shown in FIG. 1;

FIG. 4 is a cross-sectional view of a portion of an end wall of the control enclosure taken along line 4 -4 of FIG. 3;

FIG. 5 is a cross-sectional view of a portion of a sidewall of the control enclosure taken along line 5 -5 of FIG. 3;

FIG. 6 is a bottom perspective view of another control enclosure included in the motor assembly shown in FIG. 1;

FIG. 7 is a bottom perspective view of an additional control enclosure included in the motor assembly shown in FIG. 1;

FIG. 8 is a cross-sectional view of a portion of an end wall of the control enclosure taken along line 8-8 of FIG. 7;

FIG. 9 is a cross-sectional view of a portion of an end wall of a further control enclosure included in the motor assembly shown in FIG. 1;

FIG. 10 is a cross-sectional view of a portion of a sidewall of another control enclosure included in a motor assembly shown in FIG. 1;

FIG. 11 is a top view of an additional control enclosure included in the motor assembly shown in FIG. 1;

FIG. 12 is a top view of another control enclosure included in the motor assembly shown in FIG. 1; and

FIG. 13 is a top view of an additional control enclosure included in the motor assembly shown in FIG. 1.

### DETAILED DESCRIPTION

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

As used herein, the term “about,” “approximately,” or “substantially” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the one or more embodiments of the disclosure described herein. Furthermore, it is also to be understood that the value to which the modifier “about” refers is itself specifically disclosed herein.

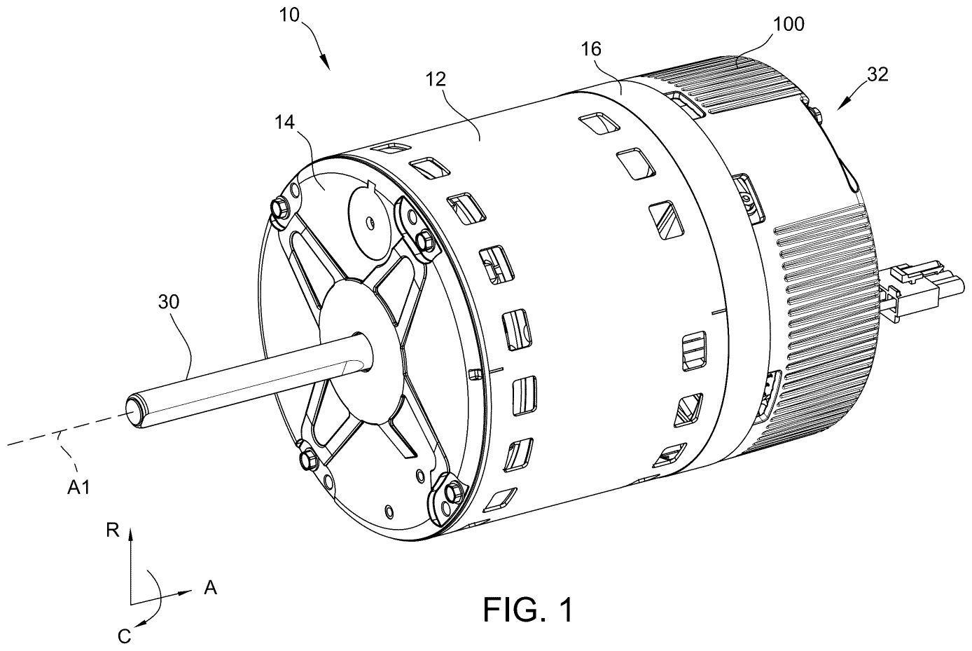

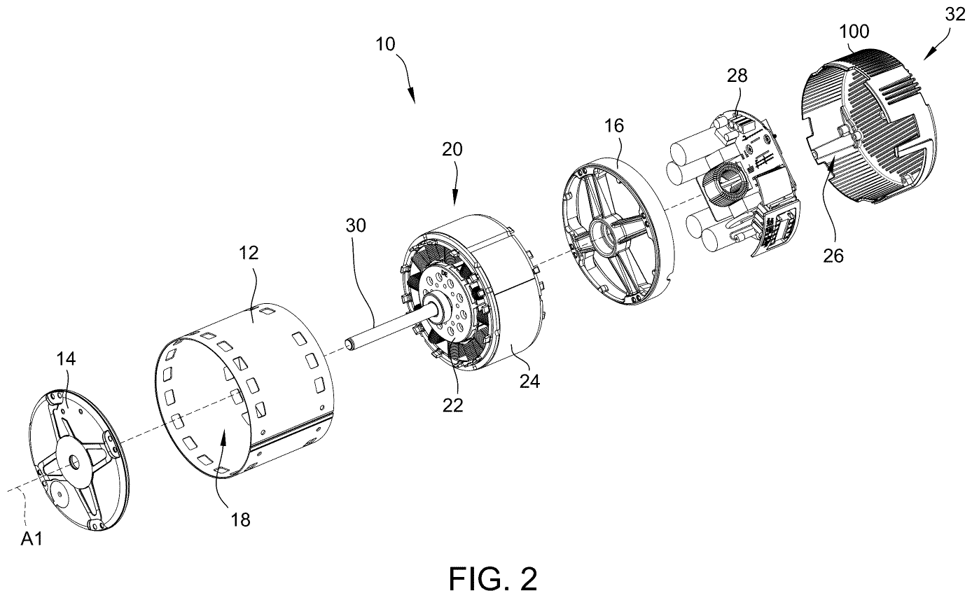

In addition, several descriptive terms may be used regularly herein, and it should prove helpful to define these terms at the onset of this section. These terms and their definitions, unless stated otherwise, are as follows. It is often required to describe parts that are at differing radial, axial and/or circumferential positions. The “A” axis represents an axial orientation. As used herein, the terms “axial” and/or “axially” refer to the relative position/direction of objects along axis A, which is substantially parallel with the shaft of the motor assembly, as discussed herein. As further used herein, the terms “radial” and/or “radially” refer to the relative position/direction of objects along a direction “R” (see, FIGS. 1 and 2), which is substantially perpendicular with axis A and intersects axis A at only one location. Finally, the term “circumferential” refers to movement or position around axis A (e.g., direction “C”). In cases such as this, if a first component resides closer to the axis than a second component, it will be stated herein that the first component is “radially inward” of the second component. If, on the other hand, the first component resides further from the axis A than the second component, it may be stated herein that the first component is “radially outward” of the second component.

Embodiments of the present disclosure are directed to control enclosures included in motor assemblies. The control enclosure includes an end wall including an inner surface and an outer surface formed opposite the inner surface, and a sidewall extending perpendicularly from the inner surface of the end wall. The sidewall includes an interior surface formed adjacent the inner surface of the end wall. The control enclosure also includes a first plurality of grooves formed in the inner surface of the end wall, and a second plurality of grooves formed in the interior surface of the sidewall. Inclusion of the first and second plurality of grooves on the inner surface and interior surface of the control enclosure increases the internal surface area of the control enclosure. The increase in the internal surface area for the control enclosure may improve heat transfer, reduce overall stress, and increase contact areas for potting materials. Additionally, the formation of the first and second plurality of grooves in the control enclosure reduces the weight, the overall thickness, and amount of material required to form the control enclosure.

FIG. 1 is a perspective view of an exemplary motor assembly 10 and FIG. 2 is a partial exploded view of motor assembly 10 depicted in FIG. 1. In an exemplary embodiment, motor assembly 10 includes at least one main frame 12 coupled to a shaft end frame 14. Main frame 12, shaft end frame 14, and lead end frame 16 combine to define a main frame cavity 18 (see, FIG. 2). Main frame cavity 18 is sized and shaped to receive at least a portion of a motor 20. That is, at least a portion of motor 20 (see, FIG. 2) of motor assembly 10 is positioned within main frame cavity 18. As shown in FIG. 2, motor 20 includes a rotor 22 and a stator 24 circumscribing rotor 22. In the exemplary embodiment, rotor 22 and stator 24 are positioned within main frame 12 and/or main frame cavity 18 of motor assembly 10.

Intermediary lead end frame 16 is positioned in proximity to motor 20 and is coupled to main frame housing 12. Intermediary lead end frame 16 is attached to at least one of main frame 12 and/or a control enclosure 100, as discussed herein. Intermediary lead end frame 16 may be attached to main frame 12 and/or control enclosure 100, either directly or indirectly, by way of fasteners, mounting features, adhesives, and combinations thereof. However, it should be understood that alternative forms of attachment may be used without departing from the spirit/scope of this disclosure. A cavity 26 (see, FIG. 2) is defined by intermediary lead end frame 16 and control enclosure 100. Cavity 26 may house and/or contain additional components of motor assembly 10 including, but not limited to, electronic control components 28, electrical interconnects, wires, and the like (hereafter, “electronic control components 28”).

In the exemplary embodiment, at least a portion of a shaft 30 is disposed through intermediary shaft end frame 16. More specifically, shaft 30 of motor 20 extends through axially aligned openings provided in shaft end frame 14, rotor 22, stator 24, and intermediary lead end frame 16, respectively. Motor assembly 10 defines an axis A1 that extends the entirety of motor assembly 10 through the aligned openings in shaft end frame 14, rotor 22, stator 24, and intermediary shaft end frame 16. Shaft 30 is aligned with axis A1.

Motor assembly 10 also includes a control enclosure 100 that is formed or positioned at an end 32 of motor assembly 10, opposite end frame 14. Control enclosure 100 is coupled to motor assembly 10, and more specifically, to intermediary lead end frame 16, such that intermediary lead end frame 16 is disposed or positioned between main frame 12 and control enclosure 100. In one embodiment, control enclosure 100 is releasably and/or removably coupled to main frame 12 and/or intermediary lead end frame 16 of motor assembly 10 using any suitable coupling component and/or technique. For example, control enclosure 100 can be releasably coupled to main frame 12 and/or intermediary lead end frame 16 using bolts-and-nuts. As shown in FIG. 2, and in combination with intermediary lead end frame 16, control enclosure 100 defines cavity 26 within motor assembly 10. In the exemplary embodiment, control enclosure 100 includes the plurality of electronic control components 28 housed therein. Electronic control component 28 are formed from any suitable components, devices, and/or systems that are configured to control the operation of motor assembly 10. Additionally, electrically coupling wires and/or interconnects (not shown) extend from electronic control components 28 housed within control enclosure 100 and are disposed within cavity 26 and/or coupled to various components (e.g., rotor 22, stator 24, shaft 30) to control components during operation.

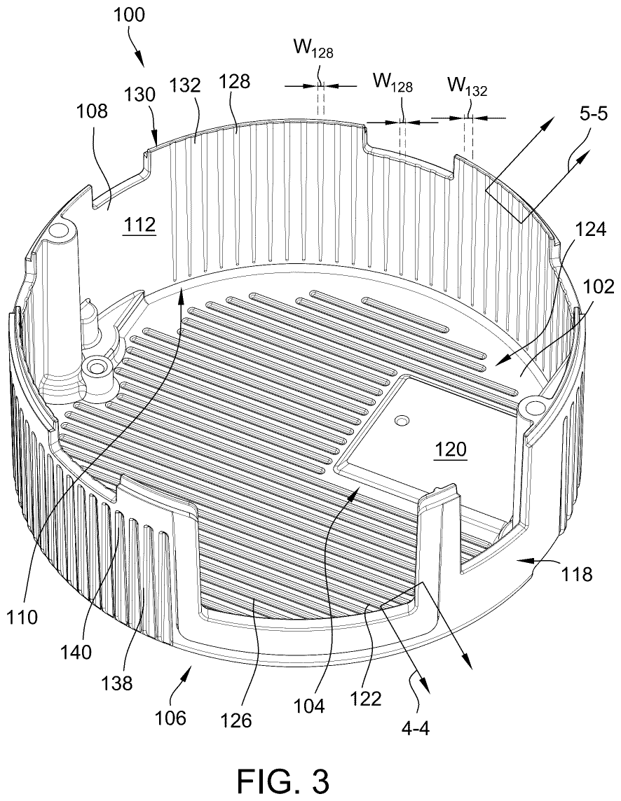

FIG. 3 is a perspective view of control enclosure 100. Control enclosure 100 is formed from any suitable material capable of absorbing, dissipating, and/or transferring heat generated by motor assembly 10 during operation. For example, control enclosure 100 is formed from, but not limited to, metal, metal alloys, polymer, ceramic, or any other suitable material including similar thermal properties. Additionally, and as discussed herein, control enclosure 100, and the features, included therein may be formed using any suitable manufacturing technique and/or process including, but not limited to, casting, injection molding, machining, additive manufacturing processes, and the like. In non-limiting examples, control enclosure 100 and all features included therein may be formed from aluminum using a casting process.

As shown in FIG. 3, control enclosure 100 includes an end wall 102 that includes an inner surface 104 and an outer surface 106 formed opposite inner surface 104. With reference to FIG. 2, inner surface 104 of end wall 102 is formed adjacent and/or in communication with cavity 26 partially defined by intermediary lead end frame 16. Additionally, electronic control components 28 contained within control enclosure 100 are positioned directly adjacent and/or coupled to inner surface 104. Outer surface 106 of end wall 102 is exposed during operation of motor assembly 10 and/or when control enclosure 100 is coupled to housing 12/intermediary lead end frame 16 of motor assembly 10. In the exemplary embodiment shown in FIG. 3, end wall 102 of control enclosure 100 is substantially circular in shape. However, it is to be understood that end wall 102 may be formed as any suitable shape, where the shape of end wall 102 depends on, at least in part, the shape and/or configuration of Main frame 12/intermediary lead end frame 16, the shape and/or size of electronic control components 28 of motor assembly 10, and/or features of motor assembly 10.

Control enclosure 100 also includes at least one sidewall 108 extending from end wall 102. More specifically, and as shown in FIG. 3, sidewall 108 extends substantially perpendicularly from end wall 102 of control enclosure 100, adjacent inner surface 104. In non-limiting examples, sidewall 108 extends from inner surface 104 and/or toward main frame 12/intermediary lead end frame 16. A joint 110 is formed between end wall 102 and sidewall 108 of control enclosure 100. Joint 110 is formed and/or defines a portion or section of control enclosure 100 where end wall 102 and sidewall 108 meet, intersect, and/or are coupled to one another. In a non-limiting example shown in FIG. 3, control enclosure 100 is formed as a unitary, integral component, such that end wall 102 and sidewall 108 are formed from a single, continuous piece of material. In other non-limiting examples, end wall 102 and sidewall 108 may be formed as two distinct components or portions that are coupled or affixed together to form control enclosure 100, as described herein. Additionally as shown in FIG. 3, sidewall 108 is substantially cylindrical in shape to match the shape of end wall 102. However, it is to be understood that sidewall 108 may be formed as any suitable shape, where the shape of sidewall 108 depends on, at least in part, the shape of end wall 102, the shape and/or configuration of main frame 12/intermediary lead end frame 16, the shape and/or size of electronic control components 28, and/or features of motor assembly 10. Although a single, substantially cylindrical sidewall 108 is shown, it is to be understood that control enclosure 100 can include a plurality of sidewalls coupled and/or affixed to end wall 102 and adjacent sidewalls to form control enclosure 100. The number of sidewalls 108 may be dependent, at least in part, on the shape of control enclosure 100, and more specifically, end wall 102.

Sidewall 108 of control enclosure 100 also includes an interior surface 112 formed adjacent inner surface 104. Interior surface 112 is formed adjacent and/or in communication with cavity 26 defined by intermediary lead end frame housing 16. Additionally, electronic control components 28 contained within control enclosure 100 are positioned directly adjacent and/or coupled to interior surface 112 of sidewall 108. Sidewall 108 also includes exterior surface 118 formed opposite interior surface 112. Exterior surface 118 of sidewall 108 is formed adjacent outer surface 106 of end wall 102. Similar to outer surface 106, exterior surface 118 is exposed during operation of motor assembly 10 and/or when control enclosure 100 is coupled to housing 12/intermediary lead end frame 16.

As shown in FIG. 3, a heat sink surface 120 is formed on inner surface 104 of end wall 10. In a non-limiting example, heat sink surface 120 is a substantially raised portion of end wall 102 and/or a portion of end wall 102 including an increased thickness. Heat sink surface 120 of control enclosure 100 may be configured to receive and/or be coupled to an electrical insulative and thermal conductive component that is capable of transmitting and withstanding increased or heightened heat exposure and/or protect electronic control components 28 in instances of an electrical surge. Heat sink surface 120 may be integrally formed with end wall 102 of control enclosure 100, or alternatively, may be formed as a distinct component that is coupled to inner surface 104 of end wall 102.

In non-limiting examples, control enclosure 100 also includes a first plurality of grooves 122 formed in inner surface 104 of end wall 102. More specifically, and as shown in FIG. 3, a first plurality of grooves 122 are formed in and/or extend partially through inner surface 104. Each of the first plurality of grooves 122 extend in a substantially similar direction and/or are parallel to one another. Additionally, each groove of the first plurality of grooves 122 are formed in inner surface 104 to extend substantially between two opposing portions of sidewall 108. In the non-limiting example shown in FIG. 3, the first plurality of grooves 122 end or cease adjacent to, but spaced apart from, joint 110 defining the intersection of end wall 102 and sidewall 108. As such, a spacer area 124 of control enclosure 100, formed adjacent to joint 110, defines an outer or radial-periphery portion of inner surface 104 for end wall 102 that surrounds the first plurality of grooves 122 formed therein. Also shown in FIG. 3, at least a portion of the first plurality of grooves 122 extend adjacent to and/or substantially surrounding heat sink surface 120. As discussed herein, the first plurality of grooves 122 improve heat transfer within control enclosure 100 during operation of motor assembly 10.

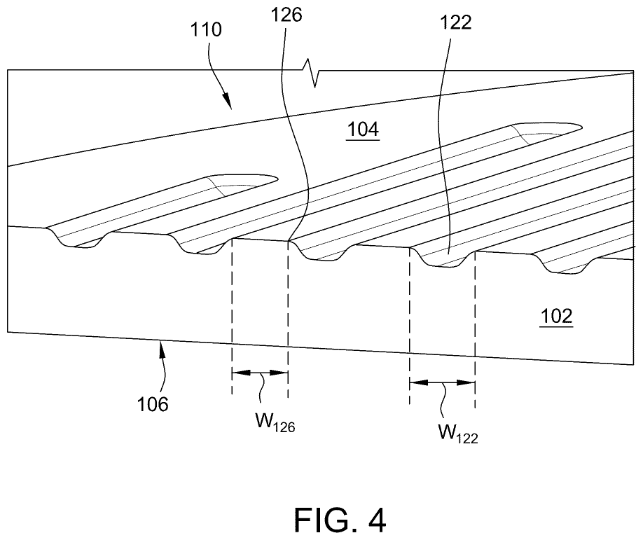

Briefly turning to FIG. 4, a cross-sectional view of a portion of control enclosure 100 taken along line 4-4 in FIG. 3 is shown. As shown in FIG. 4, control enclosure 100 includes a flat portion 126 of end wall 102 that separates each groove of the first plurality of grooves 122. More specifically, each of a plurality of flat portions 126 of inner surface 104 are positioned between and separate two adjacent grooves 122 of the first plurality of grooves 122 formed in end wall 102. Flat portions 126 are substantially planar with spacer area 124 of end wall 102. As shown in FIG. 4, each flat portion 126 of end wall 102 includes a width (W₁₂₆) defined by two adjacent grooves of the first plurality of grooves 122.

Additionally as shown in FIG. 4, each groove of the first plurality of grooves 122 includes a width (W₁₂₂). That is, each of the first plurality of grooves 122 include a single, uniform width (W₁₂₂) regardless of a length of the groove. The width (W₁₂₂) of each groove of the first plurality of grooves 122 may be defined by two adjacent flat portions 126 positioned on either side of groove 122. In a non-limiting example, the width (W₁₂₂) of each groove 122 is equal to the width (W₁₂₆) of each flat portion 126. Alternatively, the width (W₁₂₂) of each groove 122 is larger or smaller than the width (W₁₂₆) of each flat portion 126. Additionally, each groove of the first plurality of grooves 122 includes a uniform depth, measured from flat portion 126 to a lowest point or portion of each groove 122 extending at least partially though inner surface 104 of end wall 102, as discussed herein.

In other non-limiting examples, each groove of the first plurality of grooves 122 includes a non-uniform width, where the widths vary between each of the plurality of grooves 122. Additionally, or alternatively, each groove of the first plurality of grooves 122 includes a distinct depth, measured from flat portion 126 to a lowest point or portion of each groove 122. In the non-limiting example, the dept of each of the plurality of grooves 122 vary between one another.

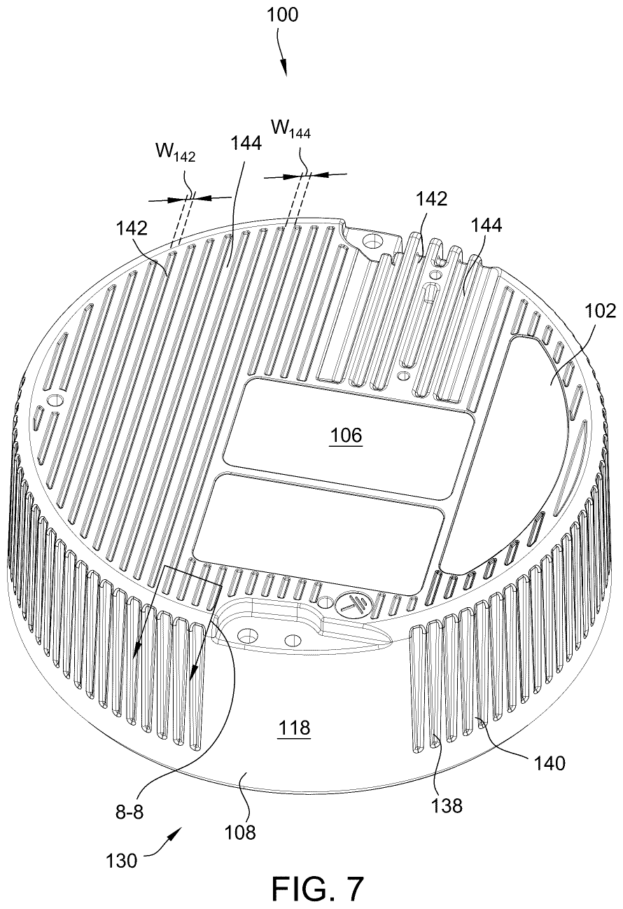

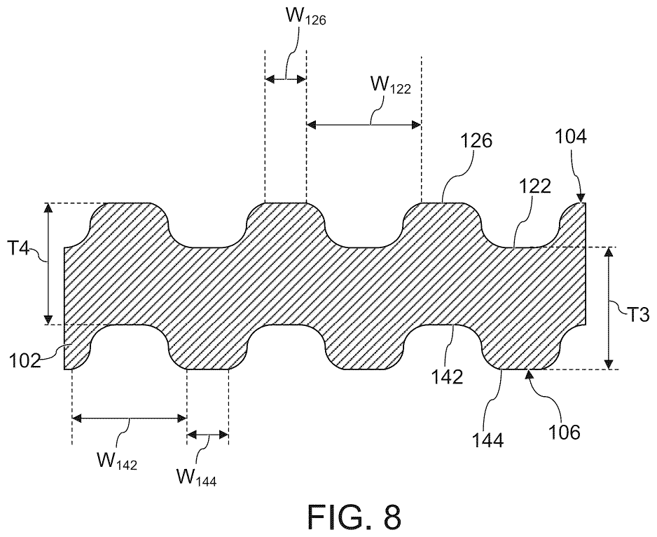

In non-limiting examples, each of the first plurality of grooves 122 include a chamfered configuration and/or shape. That is, and as shown in FIG. 4, the first plurality of grooves 122 formed partially through and/or in inner surface 104 of end wall 102 include substantially chamfered or filleted transitions between surfaces and/or edges. The first plurality of grooves 122 may include the chamfered configuration and/or shape to increase surface area within grooves 122, increase turbulence of air flow moving over and/or through grooves 122, and/or because of manufacturing processes. For example, where control enclosure 100 is formed using casting or molding processes, the first plurality of grooves 122 may be formed to include a chamfered configuration to improve the release of control enclosure 100 from the cast or mold used to form the component. In other non-limiting examples, (see, FIGS. 7 and 8), the first plurality of grooves 122 formed in inner surface 104 and/or extending partially through end wall 102 may include any suitable shape and/or configuration including, but not limited to, a filleted configuration, a rectangular configuration, a triangular configuration, and the like.

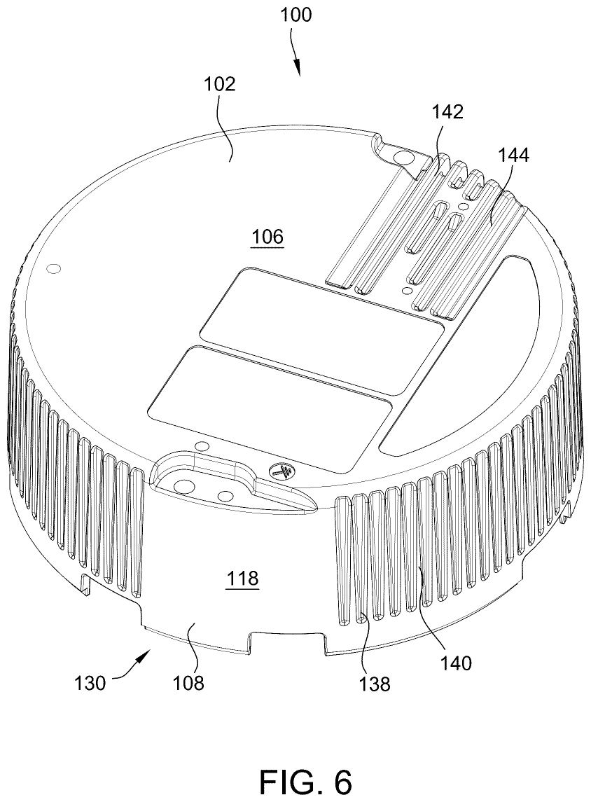

As shown in FIG. 4, and in one non-limiting example, only inner surface 104 of end wall 102 includes grooves (e.g., the first plurality of grooves 122) formed therein. In other non-limiting examples, a portion of outer surface 106 may include grooves (see, FIG. 6), or alternatively, a distinct plurality of grooves can be formed in substantially all of outer surface 106 (see, FIGS. 7 and 8).

Returning to FIG. 3, end wall 102 includes thirty (30) grooves forming the first plurality of grooves 122. However, it is understood that control enclosure 100 can include any number of grooves 122 formed in end wall 102. The number of grooves 122 is dependent, at least in part, on the width (W₁₂₂) of the first plurality of grooves 122, the width (W₁₂₆) of flat portion 126, the size of end wall 102, the shape of end wall 102, the size of heat sink surface 120, the shape of heat sink surface 120, and the like.

Control enclosure 100 also includes a second plurality of grooves 128 formed in interior surface 112 of sidewall 108. More specifically, and as shown in FIG. 3, a second plurality of grooves 128 are formed in and/or extend partially through interior surface 112 of sidewall 108. Each of the second plurality of grooves 128 extend in a substantially similar direction and/or are parallel to one another. Additionally, each groove of the second plurality of grooves 128 are formed in interior surface 112 and extend substantially between joint 110 and a top surface 130 of sidewall 108. In the non-limiting example shown in FIG. 3, the second plurality of grooves 128 end or cease directly adjacent to joint 110 defining the intersection of sidewall 108 and sidewall 108. Also shown in FIG. 3, at least a portion of the second plurality of grooves 128 extend directly adjacent to and/or substantially cease at top surface 130. As discussed herein, the second plurality of grooves 128 improve heat transfer within control enclosure 100 during operation of motor assembly 10.

In the non-limiting example, control enclosure 100 includes an intermediary portion 132 of sidewall 108 that separates each groove of the second plurality of grooves 128. More specifically, each of a plurality of intermediary portions 132 of interior surface 112 for sidewall 108 is positioned between and separates two adjacent grooves 128 of the second plurality of grooves 128 formed in sidewall 108.

Additionally as shown in FIG. 3, each groove of the second plurality of grooves 128 is tapered and/or includes a tapered width (W₁₂₈). In an exemplary embodiment, tapered width (W₁₂₈) is variable and/or decreases in width as grooves 128 extend along interior surface 112 of sidewall 108 from top surface 130 to joint 110. As such, the width of a portion of each groove 128 formed directly adjacent top surface 130 of sidewall 108 is larger or greater than a width of a distinct portion of each groove 128 formed directly adjacent joint 110.

In another exemplary embodiment (not shown), each of the plurality of grooves 128 include a uniform section and a tapered section formed adjacent the uniform section. The uniform section of each groove of the second plurality of grooves 128 is formed directly adjacent top surface 130 and extends partially through interior surface 112, toward joint 110. The tapered section is formed adjacent to uniform section, and more specifically, between joint 110 of control enclosure 100 and the uniform section. The uniform section of each of the second plurality of grooves 128 includes a uniform width defined by two adjacent intermediary portions 132 positioned on either side of grooves 128. The uniform width of the uniform section for each groove 128 may be uniform throughout the entirety of the uniform section. Distinct from the uniform section, the tapered section of each groove 128 includes a variable, tapered width. In a non-limiting example, the tapered width of the tapered section decreases as the tapered section is formed closer to joint 110. That is, the width of a portion of the tapered section formed directly adjacent the uniform section is greater than the width of a distinct portion of the tapered section formed directly adjacent joint 110. In other non-limiting examples, the entirety of each groove of the second plurality of grooves 128 may include a uniform width, such that the width of each groove 128 uniform or the same between top surface 130 and joint 110.

As shown in FIG. 3, control enclosure 100 also includes a third plurality of grooves 138 formed in exterior surface 118 of sidewall 108. More specifically, third plurality of grooves 138 are formed in and/or extend partially through exterior surface 118 of sidewall 108. Each of the third plurality of grooves 138 extend in a substantially similar direction and/or are parallel to one another. Additionally, each groove of the third plurality of grooves 138 are formed in exterior surface 118 and extend substantially from top surface 130 of sidewall 108 toward outer surface 106 of end wall 102. In the non-limiting example shown in FIG. 3, the third plurality of grooves 138 end or cease directly adjacent to top surface 130 of sidewall 108. Also shown in FIG. 3, at least a portion of the third plurality of grooves 138 extend directly adjacent to and/or substantially cease directly adjacent to outer surface 106 of end wall 102. As discussed herein, the third plurality of grooves 138 improve heat transfer for control enclosure 100 during operation of motor assembly 10.

In the non-limiting example, distinct, intermediary portion 140 of sidewall 108 separate each groove of the third plurality of grooves 138. More specifically, each of a plurality of distinct intermediary portions 140 of exterior surface 118 for sidewall 108 is positioned between and separates two adjacent grooves 138 of the third plurality of grooves 138 formed in sidewall 108.

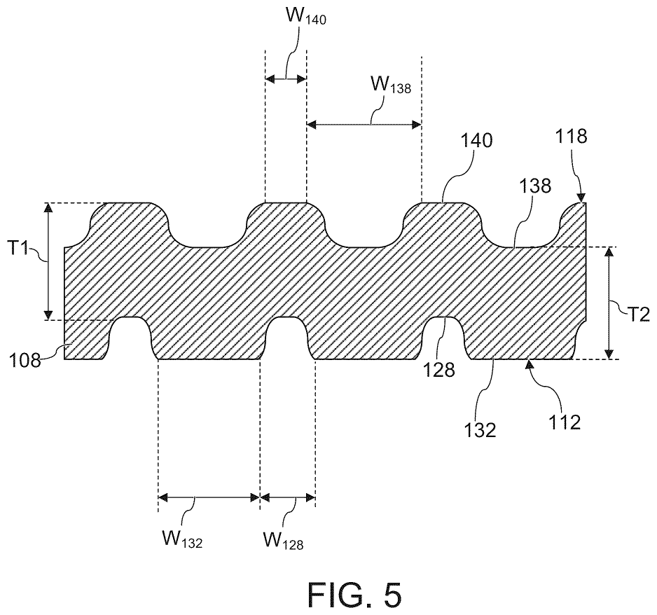

FIG. 5 illustrates a cross-sectional view of a portion of control enclosure 100 taken along line 5-5 in FIG. 3. As discussed herein, each groove of the second plurality of grooves 128 includes tapered width (W₁₂₈) (see, FIG. 3). As shown in FIG. 5, the tapered width (W₁₂₈) of each groove 128 is smaller than a width (W₁₃₂) of each intermediary portion 132. Alternatively, the width (W₁₂₈) of each groove 128 of the second plurality of grooves 128 is larger than or equal to the width (W₁₃₂) of each intermediary portion 132 positioned adjacent to and/or separating grooves 128. Additionally, each groove of the second plurality of grooves 128 includes a uniform depth, measured from intermediary portion 132 to a lowest point or portion of each groove 128 extending at least partially though interior surface 112 of sidewall 108, as discussed herein.

Additionally as shown in FIG. 5, each groove of the third plurality of grooves 138 includes a width (W₁₃₈). In the non-limiting example, the width (W₁₃₈) of each groove 138 is larger than a width (W₁₄₀) of each distinct, intermediary portion 140 formed in exterior surface 118 of sidewall 108. Alternatively, the width (W₁₃₈) of each groove 138 of the third plurality of grooves 138 is smaller than or equal to the width (W₁₄₀) of each distinct intermediary portion 132 positioned adjacent to and/or separating grooves 138. Additionally, each groove of the third plurality of grooves 138 includes a uniform depth, measured from distinct, intermediary portion 140 to a lowest point or portion of each groove 138 extending at least partially though exterior surface 118 of sidewall 108, as discussed herein.

In the non-limiting example shown in FIG. 5, the tapered width (W₁₂₈) of each groove of the second plurality of grooves 128 is also smaller than the width (W₁₃₈) of each groove of the third plurality of grooves 138. In other non-limiting examples, at least a portion of the tapered width (W₁₂₈) of each groove of the second plurality of grooves 128 is larger than or equal to the width (W₁₃₈) of each groove of the third plurality of grooves 138.

Also shown in FIG. 5, each of the second plurality of grooves 128 and the third plurality of grooves 138 are offset from one another. More specifically, each groove of third plurality of grooves 138 formed in exterior surface 118 of sidewall 108 is offset, staggered, and/or not aligned with any of the second plurality of grooves 128 formed in interior surface 112 of sidewall 108. For example, and where sidewall 108 is substantially cylindrical in shape, each of the second plurality of grooves 128 and the third plurality of grooves 138 are radially offset from one another and/or are not radially aligned with one another. Offsetting each of the second plurality of grooves 128 and the third plurality of grooves 138 within sidewall 108 ensures that sidewall 108 of control enclosure 100 maintains a desired and overall uniform thickness while including grooves 128, 138 to improve heat transfer and dissipation, as discussed herein. For example, and as shown in FIG. 5, the thickness (T1) of sidewall 108 in a portion that includes one of the second plurality of grooves 128 and distinct intermediary portion 140 is substantially equal to the thickness (T2) of sidewall 108 in a distinct portion that includes one of the third plurality of grooves 138 and intermediary portion 132.

In other non-limiting examples, although a desired and overall uniform thickness for sidewall 108 is maintained within control enclosure 100, thickness (T1) is distinct from the thickness (T2). For example, the thickness (T1) may be greater or less than the thickness of (T2). In the exemplary embodiment, the overall thickness of control enclosure 100 may be uniform even though the respective thicknesses (T1, T2) differ as a result of the respective depths, widths (W), and/or size of each groove 128, 138 formed in control enclosure 100. In additional exemplary embodiments where the thickness (T1) is distinct from the thickness (T2), the overall thickness of sidewall 108 may not be uniform within control enclosure 100.

FIG. 6 shows a perspective bottom view of control enclosure 100 of motor assembly 10. It is to be understood that similarly numbered and/or named components may function in a substantially similar fashion. Redundant explanation of these components has been omitted for clarity.

In the non-limiting example shown in FIG. 6, control enclosure 100 includes a fourth plurality of grooves 142 formed in outer surface 106 of end wall 102. More specifically, the fourth plurality of grooves 142 are formed in and/or extend partially through at least a portion of outer surface 106 of end wall 102. Each of the fourth plurality of grooves 142 extend in a substantially similar direction and/or are parallel to one another. In the non-limiting example, each groove of the fourth plurality of grooves 142 are formed in outer surface 106 and substantially aligned with heat sink surface 120 formed on inner surface 104 (see, FIG. 3). Additionally, grooves of the fourth plurality of grooves 142 may be in communication with and/or integrally formed with at least a portion of the third plurality of grooves 138 formed in sidewall 108. In the example, a continuous groove is formed in control enclosure 100 that extends from outer surface 106 of end wall 102 (e.g., the fourth plurality of grooves 142) to exterior surface 118 of sidewall 108 (e.g., the third plurality of grooves 138). In other non-limiting examples, the fourth plurality of grooves 142 formed in end wall 102 of control enclosure 100 are distinct from the third plurality of grooves 138 formed in sidewall 108. As discussed herein, the fourth plurality of grooves 142 improve heat transfer within control enclosure 100 during operation of motor assembly 10.

A distinct flat portion 144 of end wall 102 separates each groove of the fourth plurality of grooves 142. More specifically, each of the plurality of distinct flat portions 144 of outer surface 106 for end wall 102 are positioned between and separate two adjacent grooves of the fourth plurality of grooves 142 formed in end wall 102. In the non-limiting example shown in FIG. 6, distinct flat portions 144 are substantially recessed from outer surface 106 but formed above the fourth plurality of grooves 142.

As shown in FIG. 6, and similar to the first plurality of grooves 122, each groove of the fourth plurality of grooves 142 includes a width (W₁₄₂). That is, each of the fourth plurality of grooves 142 include a single, uniform width (W₁₄₂) regardless of a length of the groove. The width (W₁₄₂) of each groove of the fourth plurality of grooves 142 may be defined by two adjacent distinct, flat portions 144 positioned on either side of groove 142. In a non-limiting example, the width (W₁₄₂) of each groove 142 is equal to the width (W₁₄₄) of each distinct flat portion 144. Alternatively, the width (W₁₄₂) of each groove 142 is larger or smaller than the width (W₁₄₄) of each distinct flat portion 126 included in outer surface 106 of end wall 102.

FIGS. 7 and 8 show various views of another exemplary embodiment of control enclosure 100 of motor assembly 10. More specifically, FIG. 7 is a bottom perspective view of control enclosure 100 and FIG. 8 is a cross-sectional view of control enclosure 100 taken along line 8-8 in FIG. 7. It is understood that similarly numbered and/or named components may function in a substantially similar fashion. Redundant explanation of these components has been omitted for clarity.

As shown in FIG. 7, control enclosure 100 also includes fourth plurality of grooves 142 formed in and/or extending partially through outer surface 106 of end wall 102. Each of the fourth plurality of grooves 142 extend in a substantially similar direction and/or are parallel to one another. Additionally, each groove of the fourth plurality of grooves 142 are formed in outer surface 106 to extend substantially between two opposing portions sides of end wall 102. In the non-limiting example shown in FIG. 7, the fourth plurality of grooves 142 end or cease adjacent to, but spaced apart from, an outer corner of control enclosure 100 where end wall 102 and sidewall 108 meet. A distinct spacer area 146 of control enclosure 100 defines an outer or radial-periphery portion of outer surface 106 for end wall 102 that surrounds the fourth plurality of grooves 142 formed therein.

As shown in FIG. 8, and similar to grooves 128, 138 formed in sidewall 108, each of the first plurality of grooves 122 and the fourth plurality of grooves 142 are offset from one another. More specifically, each groove of first plurality of grooves 122 formed in inner surface 104 of end wall 102 is offset, staggered, and/or not aligned with any of the fourth plurality of grooves 142 formed in outer surface 106 of end wall 102. For example, each of the first plurality of grooves 122 and the fourth plurality of grooves 142 are offset from one another and/or are not aligned with one another. Offsetting each of the first plurality of grooves 122 and the fourth plurality of grooves 142 within end wall 102 ensures that end wall 102 of control enclosure 100 maintains a desired and overall uniform thickness while including grooves 122, 142 to improve heat transfer and dissipation, as discussed herein. For example, and as shown in FIG. 8, the thickness (T3) of end wall 102 in a portion that includes one of the first plurality of grooves 122 and distinct flat portion 144 is substantially equal to the thickness (T4) of end wall 102 in a distinct portion that includes one of the fourth plurality of grooves 142 and flat portion 126.

In other non-limiting examples, although a desired and overall uniform thickness for end wall 102 is maintained within control enclosure 100, thickness (T3) is distinct from the thickness (T4). For example, the thickness (T3) may be greater or less than the thickness of (T4). In the exemplary embodiment, the overall thickness of end wall 102 for control enclosure 100 may be uniform even though the respective thicknesses (T3, T4) differ as a result of the respective depths, widths (W), and/or size of each groove 122, 142 formed in control enclosure 100. In additional exemplary embodiments where the thickness (T3) is distinct from the thickness (T4), the overall thickness of end wall 102 may not be uniform within control enclosure 100.

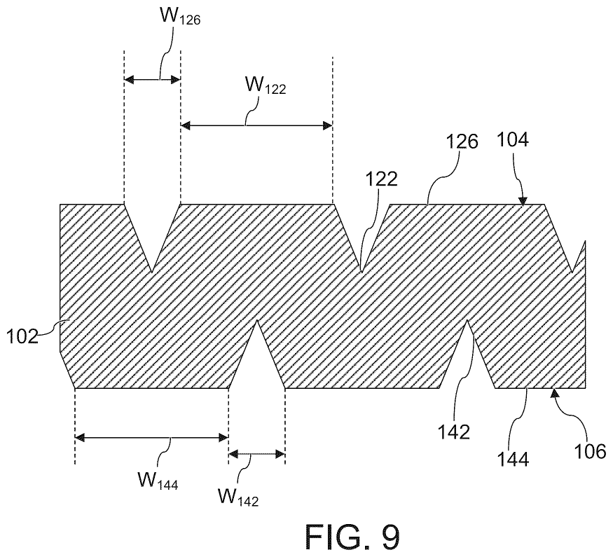

As discussed herein grooves, 122, 128, 138, 142 formed and/or included in control enclosure 100 can include any manufacturable shape and/or configuration. For example, as shown in FIG. 9, the first plurality of grooves 122 and the fourth plurality of grooves 142 are formed to include a substantially triangular shape and/or configuration within end wall 102 of control enclosure 100.

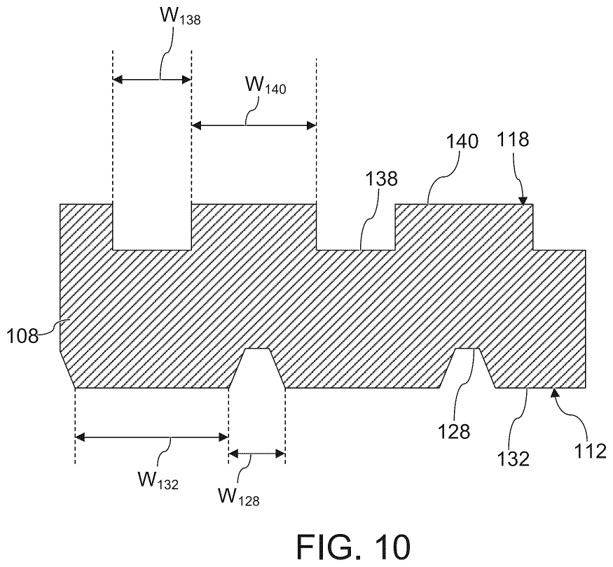

Additionally, it is to be understood that that each plurality of grooves 122, 128, 138, 142 formed and/or included in control enclosure 100 can include a distinct shape and/or configuration than distinct plurality of grooves 122, 128, 138, 142 formed in the same control enclosure 100. For example, and as shown in FIG. 10, the second plurality of grooves 128 formed in interior surface 112 of sidewall 108 are formed to include a substantially trapezoidal shape and/or configuration including sloped or angled sidewalls. However, the third plurality of grooves 138 formed in exterior surface 118 of sidewall 108 are formed to include a substantially rectangular shape and/or configuration. The shape and/or configuration of each of the plurality of grooves 122, 128, 138, 142 included in control enclosure 100 may be dependent, at least in part, upon the material used to form control enclosure 100, the manufacturing processes used to form control enclosure 100, the width (W) of grooves 122, 128, 138, 142, heat transfer requirements for control enclosure 100 during operation of motor assembly 10, and other similar characteristics.

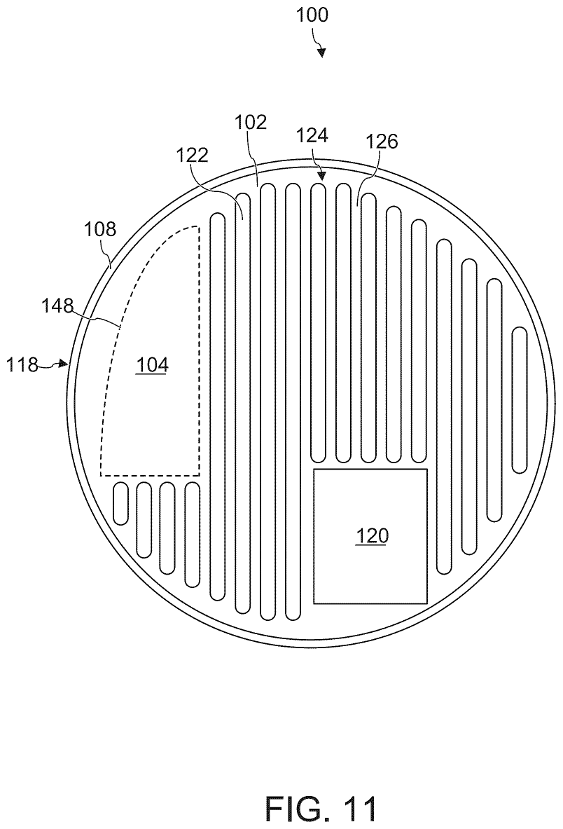

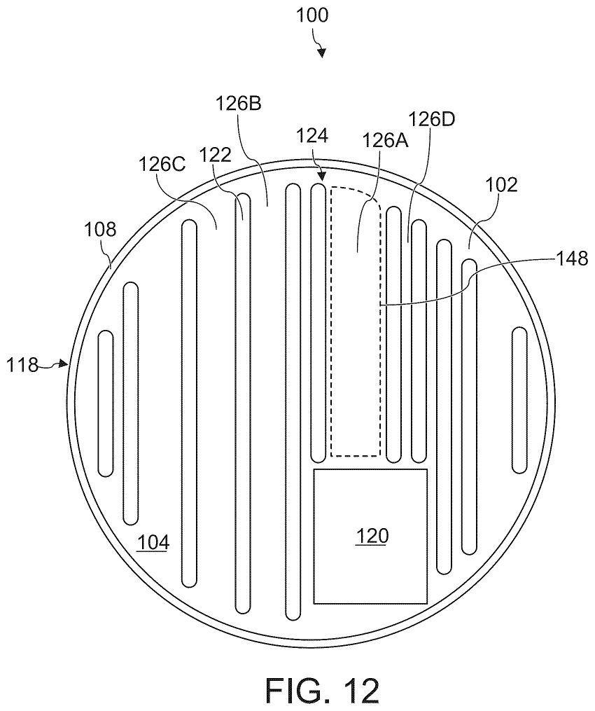

FIGS. 11 and 12 show top views of additional non-limiting examples of control enclosure 100 included in motor assembly 10 (see, FIGS. 1 and 2). In the non-limiting examples, the first plurality of grooves 122 are formed in inner surface 104 of end wall 102 such that at least one predetermined region 148 of inner surface 104 does not include grooves 122. Predetermined region 148 represents a portion of end wall 102 furthest from heat sink surface 120 and/or a region of end wall 102 that requires the least amount of heat transfer and/or dissipation during the operation of motor assembly 10. In order to maintain more uniform heat transfer within control enclosure 100, the first plurality of grooves 122 may not be formed in predetermined region 148 of inner surface 104 of end wall 102.

FIG. 12 shows another non-limiting example of control enclosure 100, where each groove of the first plurality of grooves 122 are spaced from one another at non-uniform intervals. That is, flat portion 126A may include a width that is larger than flat portions 126B, 126C, 126D, while flat portion 126B includes a width that is equal to flat portion 126C, but larger than a width of flat portion 126D. Similar to the non-limiting example shown in FIG. 11, flat portions 126A, 126B, 126C, 126D including varying widths may separate grooves of the first plurality of grooves 122 to achieve uniform heat transfer within control enclosure 100. Additionally, or alternatively, predetermined regions 148 included in some of the flat portions 126 separating grooves 122 may also identify regions or portions of end wall 102 that experience increased stress during operation. For example, predetermined region 148 identified in a portion of flat portion 126A experiences an increased stress during operation of motor assembly 10 including control enclosure 100. As a result, no groove of the first plurality of grooves 122 is formed in inner surface 104 of end wall 102 within predetermined region 148 to maintain a greater than average thickness of end wall 102 at flat portion 126A to withstand the increased stress during operation.

The inclusion of the first plurality of grooves 122 in inner surface 104 and the second plurality of grooves 128 in interior surface 112 increase the internal surface area for control enclosure 100. The increased surface area for control enclosure 100 in turn can improve operation of control enclosure 100 within motor assembly 10. For example, increases in the surface area increases a total contact area between potting material and control enclosure 100, which improves potting adhesion to control enclosure 100. The improved adhesion in turn can reduce the boundary layer thermal resistance during operation. Moreover, the formation of the first plurality of grooves 122 and the second plurality of grooves 128 within control enclosure 100 can improve heat transfer as well. For example, first plurality of grooves 122 and second plurality of grooves 128 can generate or create turbulence inside of control enclosure 100 during operation of motor assembly 10. The turbulence may increase the heat transfer generated by motor assembly 10 during operation. Additionally, the formation of grooves 122, 128, 138, 142 within control enclosure 100 reduces the thickness of end wall 102 and sidewall 108 in certain areas, and potentially the overall thickness of control enclosure 100, which may increase and/or improve heat transfer during operation of motor assembly 10. The reduced overall thickness of control enclosure 100, and specifically end wall 102 and/or sidewall 108, is a result of the improved heat transfer as well as a reduction of overall stress on control enclosure 100 because of the inclusion of grooves 122, 128 therein. Furthermore, with a reduction in thickness and the inclusion of grooves 122, 128, the overall mass and/or material requirement to create and manufacture control enclosure 100 is decreased, thus creating a lighter-weight and less expensive component used in motor assembly 10.

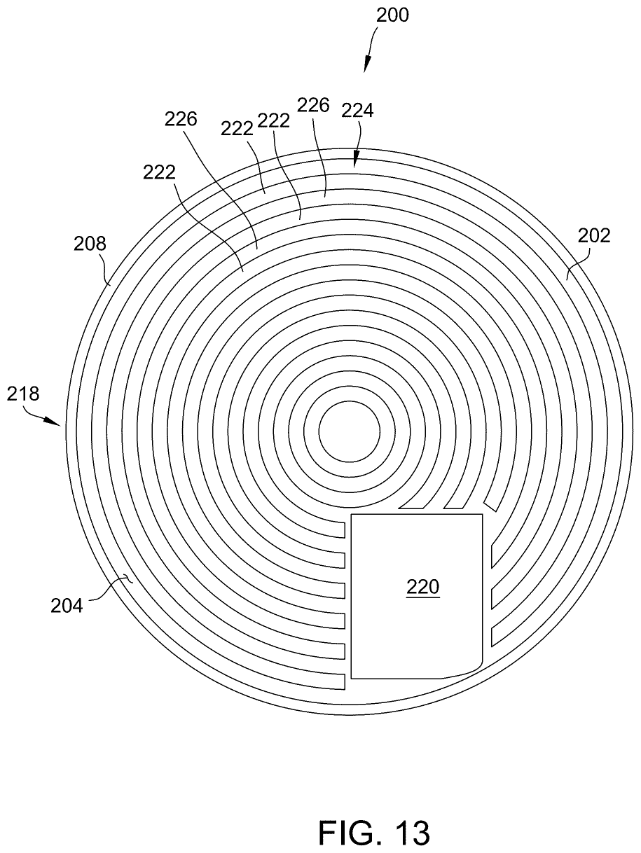

FIG. 13 shows a top view of another exemplary embodiment of control enclosure 200 of motor assembly 10. It is understood that similarly numbered and/or named components may function in a substantially similar fashion. Redundant explanation of these components has been omitted for clarity.

In the non-limiting example, the first plurality of grooves 222 are formed in inner surface 204 of end wall 202, as discussed herein. However as shown in FIG. 13, each of the plurality of grooves 222 are substantially concentric one another. Additionally, each groove of the plurality of concentric grooves 222 are separated by flat portions 226 of inner surface 204 of end wall 202. Similar to the plurality of grooves 222, each flat portion 226 separating grooves 222 are substantially concentric to one another and/or substantially concentric with each of the plurality of grooves 222 formed in inner surface 204. In non-limiting examples, the width of each of the plurality of concentric grooves 222 are uniform, with one another and/or each flat portion 226, or alternatively, are non-uniform. Additionally, or alternatively, the width of each of the plurality of flat portions 226 are uniform with one another and/or each of the plurality of grooves 222, or alternatively are non-uniform. As shown in FIG. 13, at least a portion of the plurality of concentric grooves 222 end and/or are formed adjacent to and/or substantially surround heat sink surface 120 of control enclosure 100.

Exemplary embodiments of rotor assemblies and stator assemblies for electric motor assemblies and systems are described above in detail. The motor assembly and its components are not limited to the specific embodiments described herein, but rather, components of the systems may be utilized independently and separately from other components described herein. For example, the components may also be used in combination with other motor systems, methods, and apparatuses, and are not limited to practice with only the systems and apparatus as described herein. Rather, the exemplary embodiments can be implemented and utilized in connection with many other applications.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A control enclosure for a motor assembly, the control enclosure comprising:
an end wall including an inner surface and an outer surface opposite the inner surface;
a sidewall extending perpendicularly from said inner surface of said end wall, said sidewall including an interior surface formed adjacent said inner surface of said end wall;
a first plurality of grooves in said inner surface of said end wall; and
a second plurality of grooves in said interior surface of said sidewall.

2. The control enclosure of claim 1, wherein each of said first plurality of grooves are evenly spaced apart and separated by a flat portion of said end wall.

3. The control enclosure of claim 1, wherein at least a portion of said second plurality of grooves extend from a top surface of said sidewall to adjacent a joint formed between said end wall and said sidewall, the joint opposite the top surface.

4. The control enclosure of claim 3, wherein at least a portion of said second plurality of grooves include:
a uniform section including a first width, and
a tapered section formed adjacent the uniform section, said tapered section formed adjacent the joint and including a variable, tapered width.

5. The control enclosure of claim 1, further comprising a third plurality of grooves in an exterior surface of said sidewall, opposite the interior surface.

6. The control enclosure of claim 5, wherein each of said third plurality of grooves are offset from each of said second plurality of grooves.

7. The control enclosure of claim 5, further comprising a fourth plurality of grooves in the outer surface of said end wall, opposite said first plurality of grooves.

8. An assembly for a motor assembly, the assembly comprising:
at least one main frame defining an internal main frame cavity; and
a control enclosure coupled to an end of said at least one main frame, said control enclosure including:
an end wall including an inner surface and an outer surface opposite the inner surface;
a sidewall extending perpendicularly from said inner surface of said end wall, said sidewall including an interior surface adjacent said inner surface of said end wall;
a first plurality of grooves in said inner surface of said end wall; and
a second plurality of grooves in said interior surface of said sidewall.

9. The assembly of claim 8, wherein each of said first plurality of grooves are evenly spaced apart and separated by a flat portion of said end wall.

10. The assembly of claim 8, wherein at least a portion of said second plurality of grooves extend from a top surface of said sidewall to adjacent a joint formed between said end wall and said sidewall, the joint opposite said top surface.

11. The assembly of claim 10, wherein at least a portion of said second plurality of grooves include:
a uniform section including a first width, and
a tapered section formed adjacent said uniform section, said tapered section formed adjacent the joint and including a variable, tapered width.

12. The assembly of claim 8, further comprising a third plurality of grooves in an exterior surface of said sidewall, opposite said interior surface.

13. The assembly of claim 12, wherein each of said third plurality of grooves are offset from each of said second plurality of grooves.

14. The assembly of claim 12, further comprising a fourth plurality of grooves in said outer surface of said end wall, opposite said first plurality of grooves.

15. A motor assembly comprising:
an assembly including:
at least one main frame defining an internal main frame cavity; and
a control enclosure coupled to an end of said at least one main frame, said control enclosure including:
an end wall including an inner surface and an outer surface opposite said inner surface;
a sidewall extending perpendicularly from said inner surface of said end wall, said sidewall including an interior surface formed adjacent said inner surface of said end wall;
a first plurality of grooves in said inner surface of said end wall; and
a second plurality of grooves in said interior surface of said sidewall; and
a motor disposed within the internal main frame cavity, said motor including a shaft.

16. The motor assembly of claim 15, wherein each of said first plurality of grooves are evenly spaced apart and separated by a flat portion of said end wall.

17. The motor assembly of claim 15, wherein at least a portion of said second plurality of grooves extend from a top surface of said sidewall to adjacent a joint formed between said end wall and said sidewall, the joint opposite said top surface.

18. The motor assembly of claim 17, wherein at least a portion of said second plurality of grooves include:
a uniform section including a first width, and
a tapered section formed adjacent said uniform section, said tapered section adjacent the joint and including a variable, tapered width.

19. The motor assembly of claim 15, further comprising a third plurality of grooves in an exterior surface of said sidewall, opposite said interior surface.

20. The motor assembly of claim 19, wherein each of said third plurality of grooves are offset from each of said second plurality of grooves.
